(19) United States
(12) Patent Application Publication
(10) Pub. No.: US 2006/0172433 A1
(43) Pub. Date: Aug. 3, 2006

(54) Liquid sampling utilizing ribbed pipette tip for barrier penetration

(76) Inventor: Arta Motadel, San Diego, CA (US)

Correspondence Address: AARON T. OLEJNICZAK;Andrus, Sceales, Starke & Sawall, LLP, Suite 1100, 100 East Wisconsin Avenue, Milwaukee, WI, 53202-4178, US

(21) Appl. No.: 11/045,534

(22) Filed: Jan. 28, 2005

(51) Int. Cl. B01L 3/02

(52) U.S. Cl. 436/180

(57) ABSTRACT

An apparatus and method for liquid sampling utilizing a ribbed pipette tip for barrier penetration is disclosed herein. The unique, disposable plastic pipette tip of the present invention has an outer surface with at least three ribs extending longitudinally along the outer surface of the barrel. Each rib is circumferentially spaced from one another at a uniform distance, with each rib being symmetrically sized and positioned on the pipette tip barrel. The pipette tip is capable of being placed on a mounting shaft of a hand-held pipette or on the mounting head of an automated liquid handling machine. The pipette tip is rigid and straight enough to pierce a barrier sheet or resilient barrier sealing a container holding a liquid to be sampled. The ribs of the pipette tip operate to keep the barrier separated from the outer surface of the pipette tip such that ambient air is allowed to flow into and from the interior of the sealed container assembly during aspiration of the liquid sample into the pipette tip allowing for accurate transfer of liquids while minimizing the risk of contamination. The pipette tip and method of the present invention may be utilized in an automated pipetting system to sample an array of sealed containers, such as sealed wells and the pipette tip is sufficiently. The pipette of the present invention may include a self-sealing filter to prevent cross-contamination.

### CROSS REFERENCE TO RELATED APPLICATIONS

The present application is related to an application filed concurrently herewith bearing the same title and inventorship.

### STATEMENT REGARDING FEDERALLY SPONSORED RESEARCH OR DEVELOPMENT

Not Applicable.

### INCORPORATION-BY-REFERENCE OF MATERIAL SUBMITTED ON A COMPACT DISC

Not Applicable.

### BACKGROUND OF THE INVENTION

Sealed container assemblies such as collection devices comprising a capped or sealed container or well plate are frequently used for collecting, storing and transporting chemical, biochemical and biological specimens in both research and clinical applications. Often, such specimens present a chemical or biohazardous threat; as such specimens may be pathogenic or may contain some other type of irritant or contaminant of the environment. Other times, specimens must be isolated to prevent cross-contamination and also to prevent introduction of contaminants that could alter the results of the analysis to be performed on the chemical, biochemical or biological sample. Accordingly, such collection devices are constructed to be essentially leak proof when sealed or capped. The assemblies may take many forms, as mentioned, from capped cylindrical vessels to sealed well plates to an array of sealed cluster tubes.

As is well known in the biotechnological industry, cross-contamination concerns are significant, particularly when nucleic acid amplification procedures such as polymerase chain reaction (PCR) or transcription based amplification systems (TAS), such as transcription-mediated amplification (TMA). These nucleic acid amplification procedures are intended to enhance assay sensitivity by increasing the quantity of the nucleic acid sequences to be analyzed. Thus, transferring even a minute amount of a contaminating specimen from another container, or from the environment, may easily result in a false-positive result.

In order to reduce contamination in these applications, it is known to use container assemblies sealed with a barrier sheet such as a pierceable foil, film or tape. It is also well known to use conventional pipette tips to puncture such sealed containers to access the specimens or samples contained therein. However, when a container, and particularly a well plate, is sealed with a barrier sheet and punctured by a conventional pipette tip, an aerosol spray often results upon puncture. This is due to the fact that the forces needed to puncture the barrier sheet compress the foil before penetration, creating a violent puncture that releases aerosols when the tip penetrates the barrier sheet. These aerosols can cause cross-contamination.

Additionally, conventional pipette tips used to puncture barrier sheets normally have a barrel portion with a smooth outer surface that tapers to a distal opening used for penetration. After the tip penetrates the barrier sheet, it moves through the barrier sheet so that the distal end contacts the liquid to be sampled and becomes submerged in the sample. Since the tip tapers toward the distal end, the circumference of the barrel moving through the barrier sheet increases often causing the pierced barrier sheet to form a tight seal around the barrel. This is problematic because a vacuum can be created that may compromise accurate aspiration of the liquid to be sampled. To avoid this problem, it is known to retract the tip slightly before aspiration thereby allowing for an appropriate flow of air for accurate pipetting. However, retraction may create additional problems. For example, retraction of tip can cause a sudden release of the displaced air, releasing additional aerosols. Furthermore, after retraction, the tip may not be submerged to an optimum location in the sample, again creating inaccuracies in the transfer of liquids and possibly leaving unwanted remnants behind in the punctured containers.

As an alternative to sealing tapes and foils in research applications, it is known to use resilient rubber or silicone plugs with cluster tubes or well plates or resilient mats that cover the entire surface of a multi-well plate. Such mats often include a plurality of extrusions or plugs corresponding to the wells in the multi-well plate. Each extrusion or plug is designed to fit firmly into a well, and once in place, lateral movement of the mat is prevented. In order to aspirate a sample from the wells when the mat is in place, it is either necessary to use a needle and syringe combination to pierce the mat, otherwise it is necessary to remove the entire mat in order to aspirate a sample from the wells with a pipette tip. It is known to provide slits in such plugs or extrusions in order to facilitate multiple, automatically resealable penetrations by a syringe or even a pipette tip.

In clinical applications, it is well known to use vials with threaded caps or closures wherein the closures comprise, at least in part, a resilient barrier member or septum to separate an interior of the container from the ambient environment. The resilient septum is capable of being penetrated by a fluid transfer device, such as a needle and syringe assembly, while the closure remains physically threaded in place on the associated container. Preferably, the resilient septum is automatically resealing, i.e., the barrier is sufficiently resilient to close and reseal after the sampling apparatus has been removed. Examples of these types of containers are the Vacutainer® manufactured by Becton Dickinson and the container closure disclosed in PCT Application No. WO 01/94019. These types of containers are primarily designed for use with a needle and syringe combination because disposable pipette tips lack the necessary rigidity and straightness for effective penetration and sampling.

It is desirable to use disposable pipette tips to take samples from container assemblies having a threaded cap in both traditional research and clinical environments. In that respect, U.S. Pat. Nos. 6,716,396 (“the '396 patent”) and U.S. Pat. No. 6,723,289 (“the '289 patent”) are directed to the use of a ribbed pipette tip and an easily penetrable, threaded cap. The cap forms an essentially leak proof seal with the container, and has a conical top portion constructed of stiff, striated plastic such as high-density polyethylene, low-density polyethylene or a mixture of the two types of polyethylene. The '396 and '289 patents also disclose a pipette tip having ribs and/or grooves on the lower body portion for use with the stiff, striated cap. The striations are easily broken by the ribbed tip, thus allowing the tip to penetrate through the stiff, conical top without bending the tip. In addition, the walls of the conical top spread when the tip is inserted thereby leaving adequate space for ventilation. One of the obvious drawbacks of this system is that the cap is not resealable. Moreover, it does not appear to prevent aerosol contamination and cross contamination particularly well. To date, however, the tip disclosed in the '396 and the '289 patents has not been used to penetrate barrier sheets, such as foil or film sheet covering a well plate, nor has it been used to penetrate resilient plugs or septum such as those commonly used in the market as described above.

### SUMMARY OF THE INVENTION

The present invention is directed to a ribbed pipette tip and the use thereof for liquid sampling. The tip of the present invention is particularly well suited for applications involving, on one hand, the piercing of resilient barriers, such as resilient plugs or septum of the type disclosed in WO 01/94019, and, on the other hand, the piercing of barrier sheets, such as foil or film barrier sheets covering well plates. The present invention solves the contamination problems associated with aspirating liquid from a sealed container assembly, whether the sealed container assembly includes a resilient barrier or a pierceable barrier sheet.

The method of the present invention contemplates sampling a liquid sample or a plurality of liquid samples, each contained in a sealed container assembly using a unique, disposable pipette tip. The liquid sample or samples are contained in sealed container assemblies, having a closed bottom portion, an open top portion and a closure associated with the top portion of the container that seals the open end of the container. The liquid sample specimen is contained in the bottom portion of the container. The closure includes, at least in part, either a barrier sheet or a resilient barrier that separates the interior of the container from the ambient environment. If the barrier is a resilient barrier it is preferred that this barrier is an automatically resealing barrier. When a plurality of liquid samples are to be diagnosed, particularly via robotic liquid handling apparatus or system, the sealed container assemblies are arranged in columns and rows so as to form a two dimensional array, such as in the well plates that are well known in the art.

A unique, disposable plastic pipette tip is provided and is intended to be used in conjunction with the method of the present invention. The innovative pipette tip comprises a hollow body and an opening at its proximal end for mounting the pipette tip to a mounting shaft of a pipettor or to a mounting head of an automated liquid handling system configured to accept an array of pipette tips. The pipette tip further includes a distal opening for aspirating liquid into and dispensing liquid from the hollow body. A collar section encircles and extends from the proximal opening of the pipette tip and a barrel portion extends from the collar to the distal opening.

The barrel of the pipette tip has an outer surface with at least one rib extending longitudinally along the outer surface of the barrel. Preferably, the barrel includes at least four ribs. If there is more than one rib, each rib is circumferentially spaced from one another, at a uniform distance, with each rib being symmetrically sized and positioned on the pipette tip barrel. Each circumferentially spaced rib has an apex, and the distance from the outer surface or apex of each rib to a central longitudinal axis passing through the hollow body of the pipette tip is such that an imaginary line passing through an apex to an adjacent apex in a plane perpendicular to the central longitudinal axis does not otherwise intersect the outer surface of the pipette tip barrel.

According to the method of the present invention, the pipette tip is placed on a mounting shaft of a pipettor or on a mounting head of an automated liquid handling machine. A sealed container assembly is provided, wherein a barrier seals the assembly with a sample or specimen enclosed therein. The distal end of the pipette tip barrel pierces the barrier and moves the barrel through the barrier until the distal opening is submerged in the liquid sample specimen held in the sealed container assembly. If the barrier being pierced is a barrier sheet, such a foil or film sheet covering a well plate, each rib on the pipette tip barrel radially shears the barrier sheet outwardly form the point where the distal end of the pipette tip first penetrated the barrier sheet. Liquid is aspirated from the container into the pipette tip through the submerged distal opening. While aspirating, the circumferentially spaced ribs on the pipette tip operate to spread the pierced opening in the barrier such that ambient air is able to flow into and from the interior of the sealed container assembly during aspiration of the liquid sample into the pipette tip. Finally, the pipette tip containing aspirated liquid sample from the sealed container is removed. If the barrier comprises a resilient, automatically resealing member, the pierced opening in the automatically resealing member is allowed to close.

The unique, disposable pipette tip of the present invention may include a self-sealing filter. Use of a self-sealing filter is advantageous because during the aspiration of a liquid, aerosols form and may be carried up through the hollow interior of a pipette tip to contact and contaminate the mounting shaft or head of pipette or automated liquid handling machine. The presence of self-sealing filters in the pipette tip eliminates the additional source of contamination. Preferably, the self-sealing filter is of the type described in U.S. Pat. No. 5,156,811, the subject matter of which is incorporated herein by reference.

### BRIEF DESCRIPTION OF THE DRAWINGS

FIG. 1 is a perspective view of a ribbed pipette tip of the present invention;

FIG. 2 is a longitudinal view of the pipette tip of FIG. 1;

FIG. 3 is a bottom view of the pipette tip of FIG. 1;

FIG. 4 is a longitudinal cross-section of the pipette tip of the present invention taken along line 4-4 of FIG. 2;

FIG. 5 is a longitudinal cross-section of a pipette tip of the present invention wherein a automatically resealing barrier has been inserted to block cross-contamination from aerosols.

FIG. 6 is a sectional view taken along line 6-6 of FIG. 2 demonstrating an imaginary line perpendicular to the longitudinal axis of the pipette tip and passing through an apex of a rib on the outer surface of a barrel portion of the pipette tip to an adjacent apex, such that imaginary line does not otherwise intersect the outer surface of the barrel.

FIG. 7 is a sectional view demonstrating the barrel of a pipette tip of the present invention penetrating a septum;

FIG. 8 is a top view of the pipette tip of the present invention penetrating a septum, taken along line 8-8 of FIG. 7;

FIG. 9 is a perspective view of a robotic arm of a liquid handling apparatus capable of holding an array of pipette tips of the present invention and a sealed well plate for carrying specimens to the sampled by the robotic arm;

FIG. 10 is a perspective view of a robotic arm of a liquid handling apparatus carrying an array of pipette tips of the present invention and further demonstrating a sealed well plate that has been penetrated by the tips carried on the robotic arm.

FIG. 11 is a top view of the pipette tip of the present invention piercing a barrier sheet of a sealed well plate.

### DETAILED DESCRIPTION OF THE INVENTION

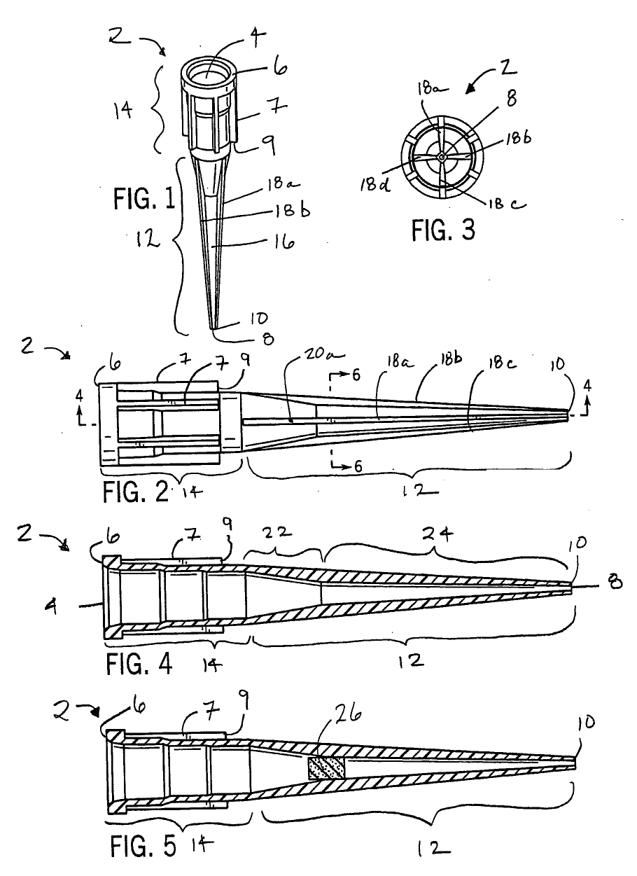

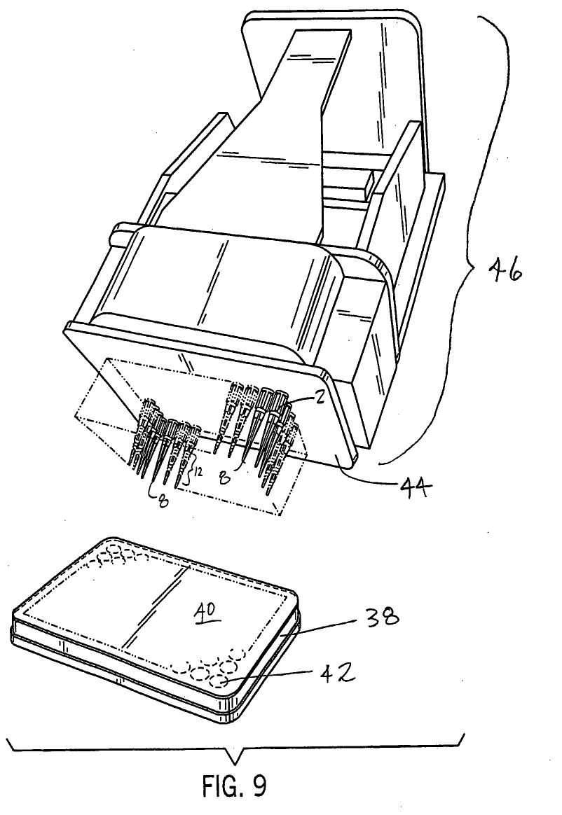

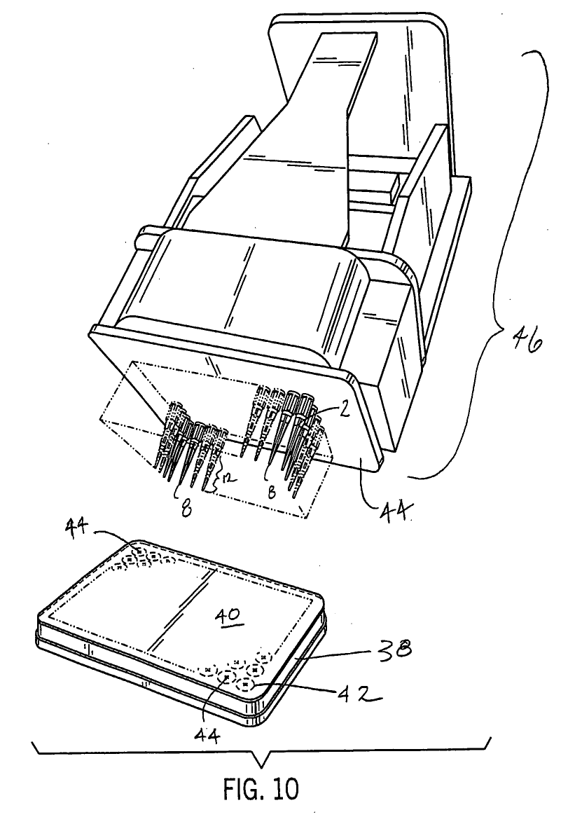

With reference to FIGS. 1 through 5, a preferred disposable pipette tip 2 comprises a hollow body having a proximal opening 4 at its proximal end 6 for mounting to a mounting shaft of a pipettor (not shown) or mounting head of an automated liquid handling apparatus (e.g. 46 of FIGS. 9 and 10) The pipette tip 2 further includes a distal opening 8 located a distal end 10 of the pipette tip 2. The distal opening 8 contacts a liquid to be sampled and allows for the liquid to be aspirated into the hollow portion of a barrel 12 of the pipette tip. The pipette 2 includes a collar portion 14 encircling and extending axially from proximal opening 4. Barrel portion 12 axially extends from collar portion 14 to distal opening 10. Preferably, the barrel portion 12 has an outer surface 16 with at least four ribs 18a, 18b, 18c, 18d extending longitudinally along the outer surface 16 of the barrel 12. Each rib 18a-d is circumferentially spaced from one another at a uniform distance. Further, each rib 18a-d is symmetrically sized and positioned on the pipette tip barrel, regardless of the volume of the pipette tip barrel. The tip demonstrated in FIGS. 1-5 is designed to aspirate 20 microliters. It is contemplated that pipette tips according to the present invention may be manufactured in volumes ranging from 2 microliters to 1200 microliters. Preferably, the tip 2 of the present invention is constructed of polypropylene, however the tip may alternatively be constructed of polyethylene. Additionally, the pipette tip 2 may contain additives to provide anti-static qualities such as cesa-stat, available from Winchester-Masterbatches of Winchester, Va. The pipette tip 2 may also include carbon to provide electrically conductive qualities for robotic liquid sensing capabilities, also as known in the art. Various other conventional materials may be used or added to construct the pipette tip of the present invention and are deemed to be within the scope of this invention.

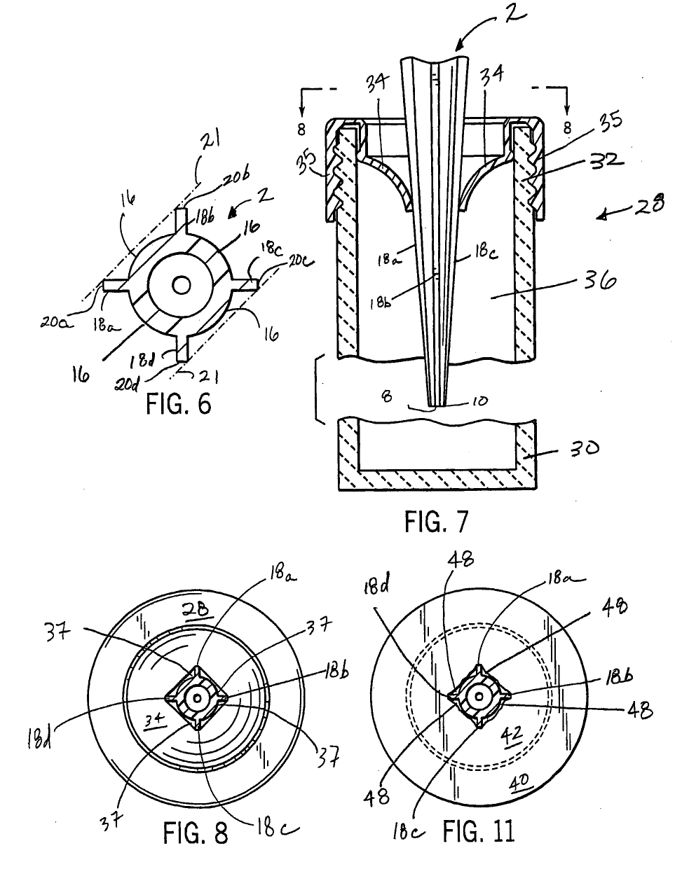

The ribs 18a-d are raised from the outside surface 16 of the barrel 12. The pipette tip 2 has a central longitudinal axis, denoted by line 4-4 in FIG. 2. Each rib 18a-d has an outer surface, point, or apex designated as 20a, 20b, 20c and 20d. As demonstrated, the outer surface 20a-d of the ribs 18a-d is preferably flat and co-planer with outer surface 16 of the barrel portion 12. However, one of skill in the art will realize that the outer surface 20a-d may take many configurations, for example, converging to a point, having a convex curve or having a concave curve. As demonstrated in FIG. 6, the ribs 18a-d are raised from outer barrel surface 16 and are spaced from one another such that an imaginary line 21 passing through the outer surface, e.g. 20a outer surface, e.g. 20b, to an adjacent apex in a plane perpendicular to the central longitudinal axis 4-4, does not otherwise intersect the outer surface 16 of the pipette tip barrel 12.

Referring again to FIGS. 1-5, Collar portion 14 is located adjacent to proximal opening 4, while barrel portion 12 is located adjacent distal opening 8 of the pipette 2. Referring particularly to FIG. 4, the barrel portion 12 has an upper barrel portion 22 and a lower barrel portion 24. The upper barrel portion 22 is located adjacent collar portion 14, while the lower barrel portion 24 is located adjacent to distal opening 8. The upper barrel portion 22 is preferably shaped in the form of a truncated cone. The lower barrel portion 24 is preferably shaped as an elongated cone. Both upper barrel portion 22 and lower barrel portion 24 have an interior taper. The taper of the upper barrel portion 22 is preferably sharper than the taper of the lower barrel portion 24, as demonstrated in FIG. 4. Referring to FIG. 2, each rib 18a-d extends longitudinally along surface 16 of barrel portion 12, along both the lower barrel portion 24 and the upper barrel portion 22. Thus, ribs 18a-d extend longitudinally completely from the area where the collar portion 14 meets the upper barrel portion 22 to the distal opening 8.

The thickness of each rib 18a-d is measured from the outer surface 16 to the outer surface or apex of each rib 20a-20d. Ribs 18a-d taper in thickness from the point where the upper barrel portion 22 and the lower barrel portion 24 intersect such that the thickness of the ribs 18a-d converges to zero as the rib approaches the distal opening 8. Similarly, the thickness of the ribs 18a-d taper from the intersection of the top barrel portion 22 and the bottom barrel portion 24 to the collar portion 14 such that as the rib approaches the collar portion 14, the thickness converges to zero.

The collar portion 14 extends along the hollow body of the pipette tip 2 longitudinally away from proximal opening 4. The inner surface of the collar portion 14 is designed such that at least a portion of the inner surface of the collar portion 14 provides a seal with a pipettor mounting shaft or the mounting head of an automated liquid handling apparatus when the pipette tip is mounted thereon. The outer surface of the collar portion 14 preferably includes a plurality of ribs 7. The ribs 7 form a shoulder 9 that connects the outer surface of the collar portion 14 to the outer surface 16 of the barrel portion 12. Alternatively, the shoulder 9 may be formed through a circumferential ring on the outer surface of the collar portion 14, through a series of spaced extensions on the outer surface of the collar portion 14.

Additionally, referring to FIG. 5, the pipette tip 2 of the of the present invention may include a filter 26 located in the hollow body of the pipette tip. Preferably, the filter 26 is located at the point where the upper collar portion 22 intersects with the lower collar portion 24. However, the filter 26 may be positioned at other positions in the hollow body as desired to prevent aerosol contamination of the pipette mounting shaft or pipetting head of a liquid handling machine. One of skill in the art will understand that to locate the filter 26 at different locations within the hollow body of pipette tip 2, the diameter of the filter 26 must be adjusted accordingly. Preferably, filter 26 is a self-sealing filter as described in U.S. Pat. No. 5,156,811.

Referring now to FIGS. 6 and 7, the previously described pipette tip 2 may be used in the following manner to realize a new and unique method of sampling a liquid from a sealed container. In the method of the present invention, a sealed container assembly 28 is provided and contained therein is a liquid sample of a specimen to be aspirated by the pipette tip 2. The sealed container assembly 28 generally includes a closed bottom portion 30 and a top portion 32 having an open end with a closure associated with the top portion 32 of container 28 to seal the open end of the container assembly 28. Typically, the liquid sample to be aspirated is located in the bottom portion 30 of the sealed container assembly 28. The closure may include, at least in part, either a barrier sheet 40 (FIGS. 8 and 9) or a resilient barrier 34 that separates the interior 36 of the container from the ambient environment. The resilient barrier 34 is preferably a automatically resealing member that is integrated into a cap portion 35 that is capable of being removably threaded onto the top portion 32 of the container assembly 28. Alternatively, the resilient barrier 34 may be placed over an array of wells or it may be a plug-type closure for well plates, cluster tubes and the like as disclosed in PCT application No. WO 01/94019.

In a method of the present invention, the disposable pipette tip 2 is mounted on the mounting shaft of a pipettor and placed into contact with resilient barrier 34. Pressure is applied, and the pipette tip 2 pierces the resilient barrier 34 of the container assembly 28 with the distal end 10 of the pipette tip 2. Subsequently, the barrel portion 12 is moved through the resilient barrier 34 until the distal opening 8 is submerged in the liquid to be sampled. The pipettor is then capable of aspirating the liquid sample from the container assembly 28 into the pipette tip 2 through the submerged distal opening 8. It is believed that the ribs 18a-d provide uniform strength and rigidity to the pipette tip 2 without significantly increasing the surface area of the distal surface 10 of the tip 2, thereby facilitating effective piercing of the resilient barrier 34.

Referring now to FIG. 7, while aspirating the liquid sample into the pipette tip 2, the ribs 18a-d function to spread the pierced opening in the resilient barrier 34 such that ambient air is able to flow into and from the interior 36 of the sealed container assembly 28 during aspiration of the liquid sample into the pipette tip 2 through vents 37. This free flow of air allows for accurate aspiration of the liquid sample. Further the ribs 18a-d allow for the free flow of air through a minimal amount of space, reducing the risk of contamination.

After the desired amount of liquid is aspirated into the pipette tip 2, the pipette tip 2 is withdrawn from the container assembly 28. In a preferred embodiment, the resilient member 34 comprises an automatically resealing member, and that automatically resealing member is allowed to close.

The method of the present invention may be used with many types of samples, including chemical samples, biochemical samples, biological samples, and particularly patient specimens. Preferably, pipette tip 2 includes a filter 26 to prevent any cross-contamination to the pipettor. Most preferably, the filter 26 is a self-sealing filter.

Referring now to FIGS. 9 and 10, a method of the present invention also contemplates sampling a plurality of liquid samples, each contained in one of a plurality of sealed container assemblies, with a plurality of disposable, plastic pipette tips of sufficient rigidity and straightness to effectively and accurately transfer liquid samples from one container to another. The sealed container preferably comprises a well plate 38 having barrier sheet 40 constructed of a non-resilient a foil or film located over the open surfaces of the individual containers or wells 42. The foil or film 40 is preferably thermo-sealed to the well plate 38, or may be adhesively sealed to the well plate 38. Other types of sealing materials other than foil or film may be utilized, and other types of sealing may further be utilized. Alternatively, the individual wells 42 of the well plate 38 may be sealed with a resilient barrier, such as a rubber or silicone mat, preferably of the type disclosed in the PCT application WO 01/94019, where the mat is constructed of silicone and includes a plurality of extrusions on a surface of the mat that corresponds to the individual wells 42 in the well plate 38 to hold the mat in place. Most preferably, the mat and extrusions are of sufficient thickness and include a slit or opening therethrough at each individual well 42 so that the openings are automatically resealing. Alternatively, individual plugs may be inserted into the individual wells 42 for sealing. Preferably, such individual plugs are automatically resealing plugs.

Each of the wells 42 in the well plate 38 contain a liquid sample, and in this manner, a plurality of liquid samples are provided. The well plate 38 is preferably a 96 well plate, but may be as large as a 1,536 well plate. As it is well known in the art, larger well plates such as a 386 or 1,536 well plate are of the same dimensions as a 96 well plate, except that the individuals wells 42 are divided out in quadrants to afford more wells. Thus, dividing the wells of a 96 well plate in to quadrants yields a 386 well plate, and dividing the wells of a 386 well plate into quadrants yields a 1,536 well plate. Further, as the number of individual wells 42 increases, the size of the individual wells 42 decrease. Therefore, it is necessary to manufacture tips according to strict specifications in order to ensure that the tips are sufficiently straight to sample from wells, of a small size, such as the wells on a 1,536 well plate. The pipette tips 2 of the present invention are manufactured to be consistently straight, and it is believed that the ribs 18a-d function to keep the barrel portion 12 consistently straight during transport and use.

In this method of the present invention, a plurality of pipette tips 2 are mounted to a mounting head 44 of a robotic arm 46 which is part of an automated liquid handling system configured to accept and array of pipette tips. The mounting head 44 of the automated liquid handling system demonstrated in FIGS. 9 and 10 accepts an array of 96 pipette tips, but may modified accept a larger number. In the preferred embodiment, where the automated pipetting system accepts an array of 96 pipette tips, the array of tips is arranged such that they correspond to the wells of the well plate 38. If the well plate 38 is a larger well plate, such as a 386 or 1,536 well plate, the automated pipetting system is capable of being configured to operate in distinct, offset quadrants to properly sample from the smaller, individual wells 42 of the larger well plates. In this manner, an automated liquid handling system may effectively sample each and every well of a large well plate such as 1,536 well plate. As mentioned above, the straightens of the tips 2 are important, particularly when large well plates are used. Accordingly, it is also very important to mount the tips 2 onto the mounting head 44 so that the tips 2 are mounted and maintained straight enough to effect proper transfer of fluids.

According to the method of the present invention, the array of pipette tips 2 when attached to mounting shaft 44 of the robotic arm 46 is capable of contemporaneously piercing at least some of the sealed wells 42 on a sealed well plate 38. The individual pipette tips 2 of the array pierce the foil or film 40 with the distal end 10 and the robotic arm 46 moves the barrel 12 of the individual pipette tips through the foil or film 40 until the distal openings 8 of the pipette tips are submerged in the liquid samples located in the individual well plates 42. As the tip 2 moves through the barrier sheet 40, each rib 18a-d radially shears the barrier sheet 40 outwardly form the point where the distal end 10 first penetrated the barrier sheet 40. The robotic arm 46 and automated liquid handling system functions to aspirate liquid samples from the individual well plates 42 into the respective pipette tips 2 through the submerged distal openings 8. Referring to FIG. 11, while aspirating the liquid samples into the respective tips 2, the ribs 18a-d on the pipette tips 2 will have sheared the barrier sheet 40 in a manner such that ambient air is able to flow into and from the interior of the respective sealed well plates 42 through vents 48 during aspiration of the sample into pipette tip 2. After the desired amount of liquid is aspirated, the robotic arm 46 removes each respective pipette tip containing an aspirated liquid sample from the respective well 42 and may transfer the liquid to a desired destination. Thus, the use of the tips 2 in this method of the present invention facilitate an easier piercing of a barrier sheet 40 than prior art tips. Particularly, the pipette tips 2 do not puncture the barrier sheet 40 in a violent fashion and further do not necessitate the retraction of the tip once the it is fully submerged to allow venting. Accordingly, the aerosol contamination is significantly reduced when this method is used in clinical or research environments.

In this method of the present invention, the container to be sampled with the array of pipette tips attached to an automated pipetting system may take many different forms. As demonstrated in FIGS. 8 and 9, the container is a well 42 in a well plate 38 having an array of wells 42, and the recited closure is a barrier sheet 40 comprised of a film or foil placed over the respective wells. Alternatively, the closure may include other types closures such as resilient plug-type closures alone or in an array integral with a sealing mat. Furthermore, the array of pipette tips 2 may operate on a container that is a cluster tube placed into a tube rack along with other cluster tubes to form an array of cluster tubes in the rack. Preferably, if an array of cluster tubes is formed, the closure is a resilient plug-type closure. However, the closure may also include a other types of resilient closures, such as an automatically resealing closure or other types of closures such as a cap having mating threads with an opening covered by a resilient, automatically resealing septum.

It should be apparent to those skilled in the art that the method and apparatus of the present invention as described herein contains several features, and that variations to the preferred embodiment disclosed herein may be made which embody only some of the features disclosed herein. Various other combinations and modification or alternatives may also be apparent to those skilled in the art. Such various alternatives and other embodiments are contemplated as being within the scope of the following claims which particularly point out and distinctly claim the subject matter regarded as the invention.

I claim:

1. A method of sampling a liquid sample from a sealed container assembly using a disposable, plastic pipette tip, the method comprising the steps of:
a) providing a liquid sample in a sealed container assembly comprising a container having a closed bottom portion and a top portion with an open end, the liquid sample being contained in the bottom portion of the container, and a closure associated with the top portion of the container that seals the open end of the container, the closure comprising at least in part a barrier sheet that separates an interior of the container from the ambient environment;
b) providing a disposable, plastic pipette tip comprising a hollow body having a proximal opening at its proximal end for mounting to a mounting shaft of a pipettor and a distal opening at its distal end for aspirating liquid into and dispensing liquid from the hollow body, the hollow body comprising a collar encircling and extending from the proximal opening, and a barrel extending from the collar to the distal opening, the barrel having an outer surface with at least one rib extending longitudinally along the outside surface of the barrel;
c) placing the recited pipette tip on a mounting shaft of a pipettor;
d) piercing the barrier on the container assembly closure with the distal end of the pipette tip barrel and moving the barrel through the barrier such that a rib of the pipette tip radially shears the barrier outwardly from a location where the distal end of the pipette tip pierced the barrier sheet and continuing to move the barrel through the barrier until the distal opening is submerged in the liquid sample in the sealed container assembly;
e) aspirating liquid sample from the container into the pipette tip through the submerged distal opening;
f) while aspirating the liquid specimen into the pipette tip, using a rib on the pipette tip barrel to spread the pierced opening in the barrier such that ambient air is able to flow into and from the interior of the sealed container assembly during aspiration of the liquid sample into the pipette tip; and
removing the pipette tip containing the aspirated liquid sample from the container assembly.

2. The method recited in claim 1 wherein at least 3 ribs extend along the outside surface of the barrel and each longitudinal rib on the barrel is circumferentially spaced from each additional rib around the outer surface of the barrel at a uniform distance from each other, and each rib is symmetrically sized and positioned on the pipette tip barrel.

3. The method recited in claim 1 wherein a central longitudinal axis passes through the hollow body of the pipette tip and an edge of the barrel defining the distal opening lies in a plane perpendicular to the central longitudinal axis.

4. The method as recited in claim 1 wherein a central longitudinal axis passes through the hollow body of the pipette tip, each rib has an apex, and the distance from the central longitudinal axis to the apex of each rib is such that an imaginary line passing through the apex to an adjacent apex in a plane perpendicular to the central longitudinal axis does not otherwise intersect the outer surface of the pipette barrel.

5. The method recited in claim 1 wherein a central longitudinal axis passes through the hollow body and the barrel has an upper barrel portion adjacent the collar and a lower barrel portion adjacent the distal opening, the upper barrel portion being in the shape of a truncated cone, the lower barrel portion being in the shape of an elongated cone in which the diameter of the hollow body tapers smaller at a lower rate with respect to longitudinal central axis than the upper barrel portion, and each rib extends longitudinally along the barrel from the lower portion to the upper portion.

6. The method recited in claim 5 wherein each rib extends longitudinally completely to the distal opening, and wherein the thickness of each rib as measured away from the outer barrel surface tapers as it approaches the distal opening so that the thickness of each respective rib from the barrel surface converges to zero as the rib approaches the edge of the barrel defining the distal opening.

7. The method recited in claim 5 wherein the thickness of each rib as measured away from the outer barrel surface tapers and converges to zero as it approaches the collar portion.

8. The method recited in claim 1 wherein the pipette tip further comprises a filter located in the hollow body of the pipette tip.

9. The method recited in claim 8 wherein the filter is a self-sealing filter.

10. The method recited in claim 1 wherein the collar extends along the hollow body of the pipette tip away from the proximal opening and at least a portion of an inside surface of the collar provides a seal when the pipette tip is mounted on the pipettor and an outer surface of the collar comprises a plurality of ribs.

11. The method recited in claim 1 wherein a central longitudinal axis passes through the hollow body of the pipette tip and at least a portion of an outer surface of the collar extends along the hollow body from the proximal opening towards the distal opening until reaching a shoulder that connects the outer surface of the collar to the outer surface of the barrel, the shoulder being substantially perpendicular to the longitudinal central axis.

12. The method recited in claim 1 wherein the recited container is a well in a well plate having an array of wells, and the recited closure is a non-resilient foil barrier sheet covering the array of wells.

13. The method recited in claim 1 wherein the recited container is a well in a well plate having an array of wells, and the recited closure is a non-resilient film barrier sheet covering the array of wells.

14. The method recited in claim 1 wherein the recited container is a cluster tube and the recited barrier sheet comprises non-resilient foil.

15. The method recited in claim 1 wherein the recited container is a cluster tube and the recited barrier sheet comprises non-resilient film.

16. A method of sampling a plurality of liquid samples each contained in one of a plurality of sealed container assemblies with a plurality of disposable, plastic pipette tips, the method comprising the steps of:
a) providing a plurality of liquid samples each in a sealed container assembly, the sealed container assemblies being arranged in columns and rows to form a two dimensional array, each sealed container assembly comprising a container having a closed bottom portion and a top portion with an open end, the respective liquid sample being contained in the bottom portion of the respective container, and a closure associated with the top portion of each container and sealing its open end, the closure comprising at least in part a barrier sheet that separates an interior of the container from the ambient environment;
b) providing a plurality of disposable, plastic pipette tips each comprising a hollow body having a proximal opening at its proximal end configured to be mounted on the mounting shaft of an automated pipetting system configured to accept an array of pipette tips and a distal opening at its distal end for aspirating liquid into and dispensing liquid from the hollow body, the hollow body comprising a collar encircling and extending from the proximal opening, a barrel extending from the collar to the distal opening, the barrel having an outer surface with at least one rib extending longitudinally along the outside surface of the barrel;
c) mounting a plurality of the recited pipette tips in an array on the mounting head for an automated pipetting system;
d) contemporaneously piercing at least a portion of the barrier sheets on the array of container assemblies with the distal end of at least some of the mounted pipette tips and moving the barrel of the pipette tips through the respective barrier sheets such that a rib radially shears the barrier outwardly from a location where the distal end pierced the barrier sheet and continuing to move the barrel through the barrier until the tip openings at the distal ends of the pipette tips are submerged in the liquid samples in the respective sealed container assemblies;
e) aspirating the liquid samples into the respective pipette tips through the submerged distal openings;
f) while aspirating the liquid specimens into the respective pipette tip, using a rib on the pipette tip barrel to spread the pierced opening in the respective barrier sheets such that ambient air is able to flow into and from the interior of the respective sealed container assembly during aspiration of the sample into the pipette tip; and
g) removing each respective pipette tip containing aspirated liquid sample from the respective container assembly.

17. The method recited in claim 16 wherein at least 3 ribs extend along the outside surface of the barrel and each longitudinal rib on the barrel of the pipette tips is circumferentially spaced from each additional rib around the outer surface of the barrel at a uniform distance from each other, and each rib is symmetrically sized and positioned on the pipette tip barrel.

18. The method recited in claim 16 wherein a central longitudinal axis passes through the hollow body of the pipette tips and an edge of the barrel defining the distal opening lies in a plane perpendicular to the central longitudinal axis.

19. The method as recited in claim 16 wherein a central longitudinal axis passes through the hollow body of the pipette tips, each rib has an apex, and the distance from the central longitudinal axis to the apex of each rib is such that an imaginary line passing through the apex to an adjacent apex in a plane perpendicular to the central longitudinal axis does not otherwise intersect the outer surface of the pipette barrel.

20. The method recited in claim 16 wherein a central longitudinal axis passes through the hollow body and the barrel has an upper barrel portion adjacent the collar and a lower barrel portion adjacent to distal opening, the upper barrel portion being in the shape of a truncated cone, the lower barrel portion being in the shape of an elongated cone in which the diameter of the hollow body tapers smaller at a lower rate with respect to longitudinal central axis than the upper barrel portion, and each rib extends longitudinally along the barrel from the lower portion to the upper portion.

21. The method recited in claim 19 wherein each rib extends longitudinally completely to the distal opening, and wherein the thickness of each rib as measured away from the outer barrel surface tapers as it approaches the distal opening so that the thickness of each respective rib from the barrel surface converges to zero as the rib approaches the edge of the barrel defining the distal opening.

22. The method recited in claim 19 wherein the thickness of each rib as measured away from the outer barrel surface tapers and converges to zero as it approaches the collar portion.

23. The method recited in claim 16 wherein the pipette tips further comprise a filter located in the hollow body of the pipette tips.

24. The method recited in claim 23 wherein the filter is a self-sealing filter.

25. The method recited in claim 16 wherein the collar extends along the hollow body of the pipette tips away from the proximal opening and at least a portion of an inside surface of the collar provides a seal when the pipette tips are mounted on the mounting head and an outer surface of the collar comprises a plurality of ribs.

26. The method recited in claim 16 wherein a central longitudinal axis passes through the hollow body of the pipette tip and at least a portion of an outer surface of the collar extends along the hollow body from the proximal opening towards the distal opening until reaching a shoulder that connects the outer surface of the collar to the outer surface of the barrel, the shoulder being substantially perpendicular to the longitudinal central axis.

27. The method recited in claim 16 wherein the recited container is a well in a well plate having an array of wells, and the recited closure is a non-resilient foil barrier sheet covering the array of wells.

28. The method recited in claim 16 wherein the recited container is a well in a well plate having an array of wells, and the recited closure is a non-resilient film barrier sheet covering the array of wells.

29. The method recited in claim 16 wherein the recited container is a cluster tube and the recited barrier sheet comprises non-resilient foil.

30. The method recited in claim 16 wherein the recited container is a cluster tube and the recited barrier sheet comprises non-resilient film.
